(19) United States
(12) Patent Application Publication
(10) Pub. No.: US 2021/0031566 A1
(43) Pub. Date: Feb. 4, 2021

(54) Asymmetrical Tire

(71) Applicants: Cord Rodman, Compton, CA (US); Doug McGoon, Los Angeles, CA (US)

(72) Inventors: Cord Rodman, Compton, CA (US); Doug McGoon, Los Angeles, CA (US)

(73) Assignee: Fusion Finish, LLC, Compton, CA (US)

(21) Appl. No.: 16/886,705

(22) Filed: May 28, 2020

Related U.S. Application Data
(60) Provisional application No. 62/856,370, filed on Jun. 3, 2019.

(51) Int. Cl. B60C 11/03; B60C 3/06; B60C 13/02

(52) U.S. Cl. CPC B60C 11/0304; B60C 13/02; B60C 3/06

(57) ABSTRACT

An asymmetrical tire is provided that includes at least a crown, a first shoulder having a first tread, and a second shoulder having a second tread. In one embodiment of the present invention, the crown and second shoulder include high-performance tread and the first shoulder includes off-road tread. By using off-road tread on the outer shoulder, the tire will have the visual aesthetics of an off-road tire. And by using high-performance tread on the crown and second shoulder, the vehicle will exhibit a smooth and quiet ride that is fuel efficient, and will not rub on, or interfere with the vehicle's wheel well or splash guard. In one embodiment, an upper portion of the first shoulder includes high-performance tread and a side portion includes off-road tread. By using two different types of tread on the outer shoulder, the tire can provide a smoother ride, while still exhibiting an off-road appearance.

### BACKGROUND OF THE INVENTION

### 1. Field of the Invention

The present invention relates to an asymmetrical tire or, more particularly, to a tire that includes (i) a first shoulder (or a portion thereof) that is different in design (e.g., lug height, width, length, groove height, width, etc.) from a second shoulder (or portion thereof) and (ii) a crown having a design (i.e., tread) that is consistent with the second shoulder. By way of example, such a tire could combine the visual aesthetics of an aggressive off-road tire with the smooth and quiet ride and fuel efficiency of an original equipment (e.g., high-performance) tire.

### 2. Description of Related Art

A tire is a ring-shaped component that surrounds a wheel's rim and functions to transfer a vehicle's load from the axle through the wheel to the ground and to provide traction on a road surface. Tires are traditionally uniform, allowing them to be rotated, and symmetrical, allowing them to be flipped. One exception is that a tire may have a first sidewall that is black and a second, opposite sidewall that is white (or has a “white wall”), allowing the tire to be flipped, depending on the color that is desired by the user.

Tires also come in various shapes and sizes. A tire is traditionally designed for a particular application. For example, a tire may be high-performance (i.e., suitable for everyday driving) (e.g., on a freeway, etc.), off-road (e.g., for mudding, etc.), winter (e.g., snow, ice, etc.), all-terrain (e.g., suitable for everyday driving but capable of certain off-road activities), etc. This is typically accomplished by varying the tire's tread. A tire's tread, which typically includes a crown and a pair of shoulders, may include a plurality of ribs, blocks, lugs, grooves, sipes, etc. By varying the height, width, and length of these features, tires can be configured for different applications (e.g., off-road, winter, etc.). For example, FIG. 1A illustrates a high-performance tire, having a plurality of ribs 110, lugs 130, grooves 140, and sipes 150, whereas FIG. 1B illustrates an off-road tire having a plurality blocks 120, lugs 130, and grooves 140. By way of example, the lugs 130 on the off-road tire are much taller, wider, and longer than the lugs on the high-performance tire. The grooves 140 are also much deeper and wider.

Tires are also designed for particular vehicles, having different widths, aspect ratios, and diameters. For example, an original manufacturer (“OM”) tire for a 2020 Toyota™ RAV4™ is a 225/65R17, meaning a tire having a 17″ diameter, a 225 mm width, and an aspect ratio of 65 (the sidewall distance, from the wheel rim to the outside of tread, is 65% of the section width). Such a tire can be seen in FIG. 2A. While this tire may provide for a smooth, quiet ride, it has the appearance of a high-performance tire, and not an off-road tire that is desired by many sports-utility vehicle (“SUV”) owners.

To acquire this look, one would have to install off-road tires (see, e.g., FIG. 1B). Such a solution, however, may not be feasible. For example, an off-road tire may not fit within the space provided by the vehicle. For example, the tread on an off-road tire generally has larger lugs and may rub on the wheel well or splash guard when the wheels are turned. For example, as shown in FIG. 3, if an off-road tire 100 is turned inward (e.g., by turning the steering wheel clockwise), the second (inner) shoulder 310 may come into contact with wheel well/splash guard 300 (e.g., at point of contact 320). One solution is to modify the vehicle (e.g., raise the suspension, remove the splash guard, etc.) so that the off-road tire 100 will fit. Such a solution, however, is not only expensive, but does not address other problems with off-road tires. For example, an off-road tire will generally provide a rougher, noisier ride. This is because taller lugs (or tread blocks) and larger voids (e.g., grooves, etc.) tend to produce more noise. An off-road tire may also result in poor fuel efficiency.

Thus, it would be advantageous to design a tire that has the visual aesthetics of an aggressive off-road tire with the smooth and quiet ride and fuel efficiency of an original equipment (e.g., high-performance) tire. This can be accomplished by designing a tire that includes a first (outer) shoulder having an off-road tread and a crown and second (inner) shoulder having a high-performance tread. In alternate embodiments, an upper portion of the first (outer) shoulder (i.e., the portion that comes into contact with the road surface) includes a high-performance tread, whereas a side portion (i.e., the portion that does not come into contact with the road surface and is visible once the tire is installed on the vehicle) includes an off-road tread. This can be seen in FIG. 2B, which shows a tire that is suitable for use on a 2020 Toyota™ RAV4™ and includes an off-road tread on a visible portion of the first (outer) shoulder.

### SUMMARY OF THE INVENTION

The present invention provides an asymmetrical tire that has the visual aesthetics of an aggressive off-road tire with the smooth and quiet ride and fuel efficiency of an original equipment (e.g., high-performance) tire. Preferred embodiments of the present invention operate in accordance with a tire configured to surround (e.g., be attached to) a wheel's rim to transfer a vehicle's load from the axle, through the wheel, to the road surface, thereby providing traction for the vehicle on the road surface.

The tire preferable includes at least one tire bead, sidewall, crown, and shoulder, where the shoulder is a transition from the crown to the sidewall. The tire bead is the part of the tire that contacts the rim on the wheel; the sidewall is that part of the tire that bridges the tread and the bead; the crown is the part of the tire that comes into contact with the road surface; and the shoulder is the part of the tire at the edge of the tread as it makes its transition to the sidewall.

The tread is characterized by a plurality of ribs, blocks, lugs, grooves, and sipes. Different tread designs address a variety of driving conditions. As the ratio of tire tread area to groove area increases, so does tire friction on dry pavement. For example, high-performance tires often have smaller voids to provide more rubber in contact with the road for higher traction, whereas off-road tires employ larger and deeper slots to engage mud, snow, etc.

It should be appreciated that a “shoulder” is a transition from the crown to the sidewall. As such, it may include a first (upper) portion that comes into contact with the road surface and may include a second (side) portion that does not, but is visible when looking at a profile (side-view) of the tire. Thus, a first shoulder having tread that is entirely different from the tread on the second shoulder, as well as partially different, is within the spirit and scope of the invention.

In one embodiment of the present invention, the crown and inner shoulder include high-performance tread and the outer shoulder includes off-road tread. By mounting the tire so that the outer shoulder points outward, the tire will have the visual aesthetics of an off-road tire. And by mounting the tire so that the inner shoulder points inward, the inner shoulder, which preferably has high-performance (e.g., OM) tread, should not rub on, or interfere with the vehicle's wheel well or splash guard. Finally, by using a high-performance tread on the crown, the vehicle should exhibit a smooth and quiet ride that is fuel efficient.

In another embodiment of the present invention, the crown and inner shoulder have a first tread design and the outer shoulder has at least a second tread design, where the first and second tread designs are different (i.e., asymmetrical). In one embodiment, the outer shoulder includes upper and side portions, where the inner shoulder has a first (e.g., high-performance) design that is consistent with (or identical to) tread on the upper surface of the outer shoulder, and the side portion of the outer shoulder has a second (e.g., off-road) design. By using two different types of tread on the outer shoulder, the tire can provide a smoother, quieter ride, while exhibiting an aggressive, off-road appearance.

In preferred embodiments of the present invention, the crown includes a plurality of ribs and grooves, and the outer and inner shoulders have a plurality of lugs, grooves, and sipes, wherein the crown and the inner shoulder comprises a first tread (e.g., high-performance) and the outer shoulder comprises a second tread (e.g., off-road). In one embodiment, the upper portion of the outer shoulder may further (or alternatively) includes a plurality of transitional comfort blocks that are consistent with the first tread type (e.g., high-performance) (e.g., have similar height, width, and/or length). As discussed above, off-road lugs are generally taller, wider, and/or longer than high-performance lugs, and the off-road grooves are deeper and/or wider as well. By using smaller ribs, lugs and grooves on the inner shoulder, the crown, and (in certain embodiments) the upper portion of the outer shoulder, and larger lugs and grooves on the side portion of the outer shoulder, an aggressive, off-road look can be provided while maintaining a smooth, quiet, comfortable ride.

A more complete understanding of the present invention will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIGS. 1A and 1B, respectively, are examples of prior art all-season and off-road tire treads;

FIG. 2A is an example of a prior art original manufacture (“OM”) tire for a 2020 Toyota™ RAV4™;

FIG. 2B illustrates an asymmetrical tire for a 2020 Toyota™ RAV4™ (installed and uninstalled) in accordance one embodiment of the present invention;

FIG. 3 shows a typical tire installed on a vehicle, where the tire is configured to move inward toward, and outward away from, an inner surface of a wheel well/slash guard in response to a user rotating a steering wheel in a clockwise/counter-clockwise fashion;

FIGS. 4, 5A, and 5B shows outer-surface features of a traditional tire, as those features are known by those skilled in the art;

FIGS. 6A and 6B illustrate an asymmetrical tire in accordance with one embodiment of the present invention;

FIG. 7 illustrates an asymmetrical tire in accordance with another embodiment of the present invention;

FIGS. 8A and 8B illustrate an asymmetric tire (installed and uninstalled) in accordance with one embodiment of the present invention;

FIG. 9 provides a front view of an asymmetrical tire in accordance with one embodiment of the present invention;

FIGS. 10A and 10B illustrate individual lugs and corresponding grooves, including the dimensions thereof, on a first (outer) shoulder (e.g., having off-road features) of an asymmetrical tire in accordance with one embodiment of the present invention;

FIGS. 11A and 11B illustrate individual lugs and corresponding grooves, including the dimensions thereof, on a second (inner) shoulder (e.g., having high-performance features) of an asymmetrical tire in accordance with one embodiment of the present invention;

FIGS. 12A-C illustrate an asymmetrical tire in accordance with an alternate embodiment of the present invention;

FIG. 13A illustrates an asymmetrical tire in accordance with a first embodiment of the present invention; and

FIG. 13B illustrates an asymmetrical tire in accordance with a second embodiment of the present invention.

### DETAILED DESCRIPTION OF THE PREFERRED EMBODIMENT

The present invention provides an asymmetrical tire that has the visual aesthetics of an aggressive off-road tire with the smooth and quiet ride and fuel efficiency of an original equipment (e.g., high-performance) tire. In the detailed description that follows, like element numerals are used to describe like elements illustrated in one or more figures.

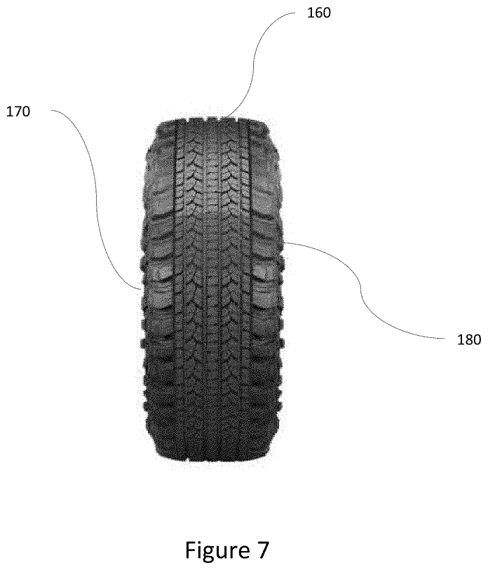

It should be appreciated that while the invention is described herein in terms of an asymmetrical tire for a vehicle, such as an automobile, the present invention is not so limited. For example, the tire could be symmetrical (see, e.g., FIG. 7), or could be used in a non-automobile application (e.g., motorcycle, bicycle, etc.), toy (e.g., toy vehicle)), machine or accessory (e.g., tractor, trailer, dolly, etc.), etc. As such, it could be made out of any material, including rubber (e.g., natural rubber, synthetic rubber, styrene-butadiene copolymer, etc.), carbon black, metal, wood, plastic, and/or other material generally known to those skilled in the art, and is applicable to both solid and pneumatic tires, and constructed (or formed) using known techniques (e.g., curing, gluing, etc.). For example, the tire could include upper tread (e.g., tread that comes into contact with the road surface) constructed using a first means (e.g., cured, etc.) and side tread (e.g., tread that does not come into contact with the road surface) constructed or affixed to tire using a second means (e.g., glue, etc.). The invention is also not limited to a tire that combines the visual aesthetics of an off-road tire and the operational properties (smooth, quiet, etc.) of a high-performance tire. For example, the tire could be the opposite (i.e., visually high-performance, operationally off-road), or any other combination of treads generally known to those skilled in the art (e.g., operationally winter, operationally all-terrain, etc.). As long as one shoulder (or portion thereof) includes tread that is different from (or inconsistent with) tread on the crown, the tire is within the spirit and scope of the present invention.

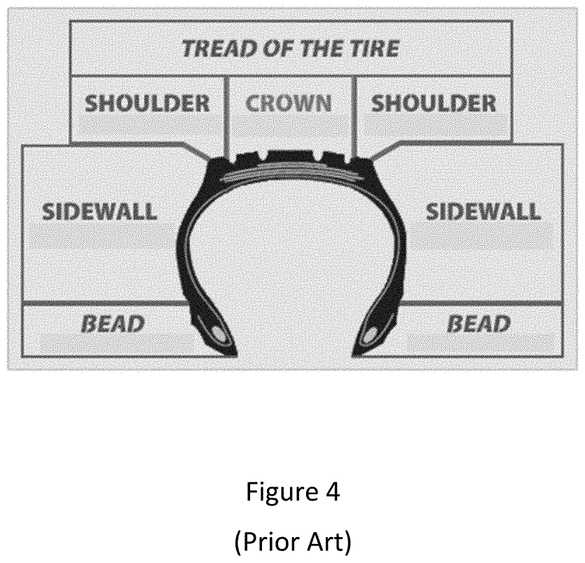

Preferred embodiments of the present invention operate in accordance with a tire configured to surround (e.g., be attached to) a wheel's rim to transfer a vehicle's load from the axle, through the wheel, to the road surface, thereby providing traction for the vehicle on the road surface. As shown in FIG. 4, the tire preferable includes a pair of beads, a pair of sidewalls, and a tread portion that includes a crown and a pair of shoulders, where each shoulder is a transition from the crown to a corresponding sidewall.

The tire bead is the part of the tire that contacts the rim on the wheel. The bead seats tightly against the two rims on the wheel to ensure that a tubeless tire holds air without leakage. The bead fit is tight to ensure that the tire does not shift circumferentially as the wheel rotates. The sidewall is that part of the tire that bridges the tread and the bead. The sidewall is traditionally rubber but may be reinforced with fabric or steel cords to provide for tensile strength and flexibility.

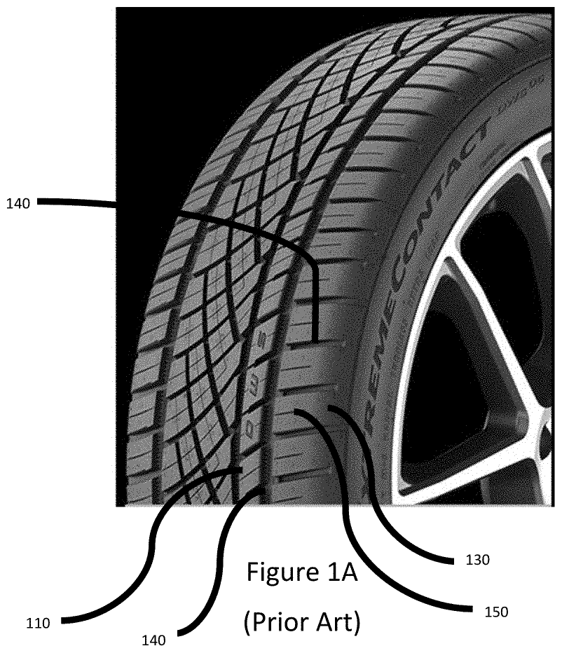

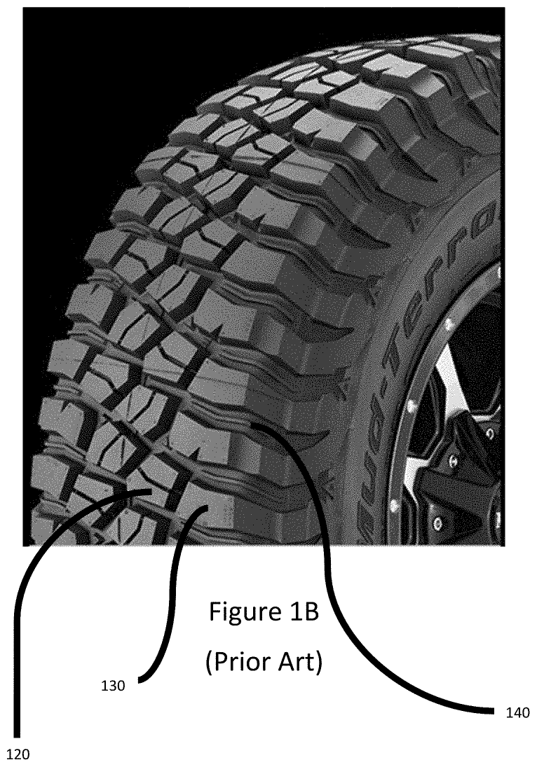

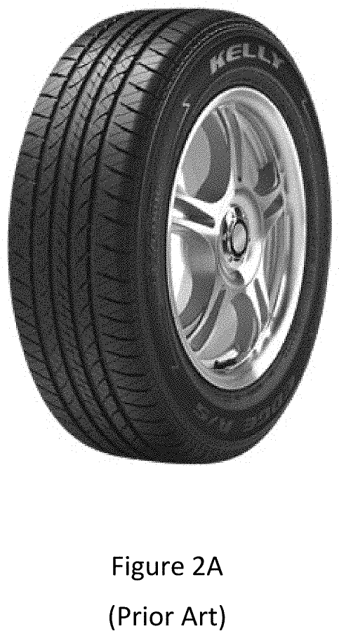

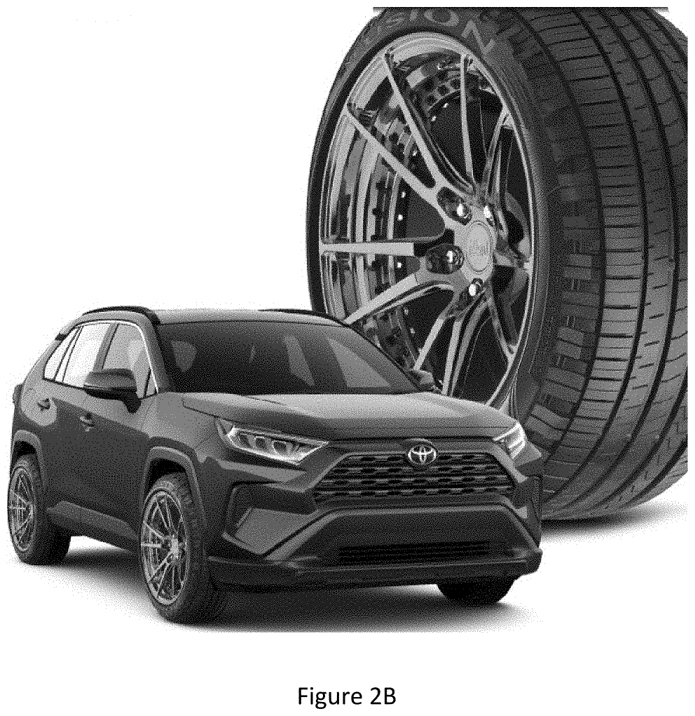

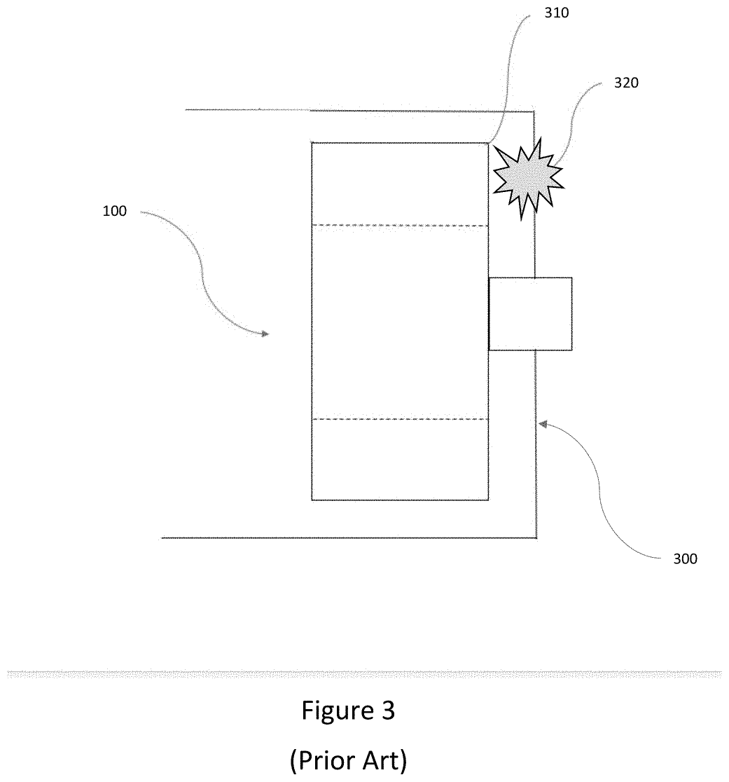

The crown is the part of the tire that comes into contact with the road surface, whereas the shoulder is the part of the tire at the edge of the tread as it makes its transition to the sidewall. The tread (crown and shoulder) is typically a thick rubber, or rubber/composite compound formulated to provide an appropriate level of traction that does not wear away too quickly. The tread pattern is characterized by a plurality of ribs, blocks, lugs, grooves, and sipes, where a rib is a continuous strip of tread around a tire's circumference (see, e.g., FIGS. 1A and B at 110), blocks are freestanding, independent sections of tread that are positioned around the tire's circumference (see, e.g., FIG. 1B at 120), a lug is an extra-large, independent section of tread positioned around the tire's circumference, typically perpendicular to the ribs (see, e.g., FIGS. 1A and B at 130), grooves are major voids between adjacent ribs, blocks, and lugs (see, e.g., FIGS. 1A and B at 140), and sipes are thin slits (or voids) that are in individual blocks or lugs, typically perpendicular to the grooves (see, e.g., FIG. 1A at 150).

Different tread designs address a variety of driving conditions. As the ratio of tire tread area to groove area increases, so does tire friction on dry pavement. High-performance tires often have smaller voids to provide more rubber in contact with the road for higher traction. They are typically constructed using softer rubber that provides better traction but wears quickly. Mud and snow (M&S) tires (e.g., off-road tires) employ larger and deeper slots to engage mud and snow. Snow tires have still larger and deeper slots that compact snow and create shear strength within the compacted snow to improve braking and cornering performance.

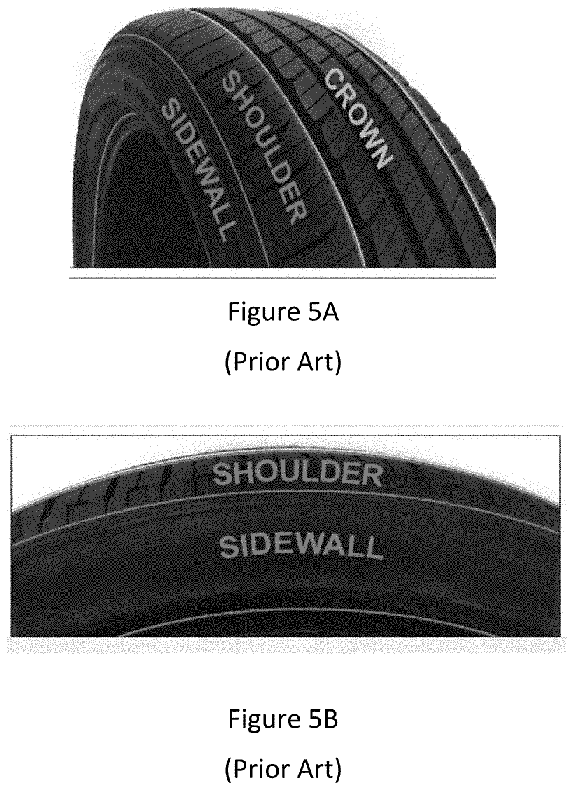

It should be appreciated that a “shoulder” is a transition from the crown to the sidewall. As such, it may include a portion (i.e., an upper portion) that comes into contact with the road surface (see FIG. 5A) and may include a portion (i.e., a side portion) that does not (see FIG. 5B), but is visible when looking at a profile (side-view) of the tire. Those skilled in the art will understand that the profile (side-view) is of utmost importance, as the purpose of the invention is to give the tire a particular look (e.g., off-road look), while maintaining certain operational requirements (e.g., high-performance operation).

Thus, a first shoulder having tread that is entirely different from the tread on the second shoulder is within the spirit and scope of the invention, as is a first shoulder having a first (upper) portion of tread (e.g., tread that comes into contact with a road surface) that is similar (or identical) to tread that is on the second shoulder and a second (side) portion of tread (e.g., tread that does not come into contact with a road surface) that is different from tread that is on the second shoulder. In other words, as long as the profile portions of each shoulder are asymmetrical, the tire would be considered within the spirit and scope of present invention, or at least the preferred embodiment thereof (see, e.g., FIG. 7 showing an alternate embodiment that is still within the spirit and scope of the present invention) (i.e., where the first and second shoulders, or at least second (side) portions thereof, are symmetrical).

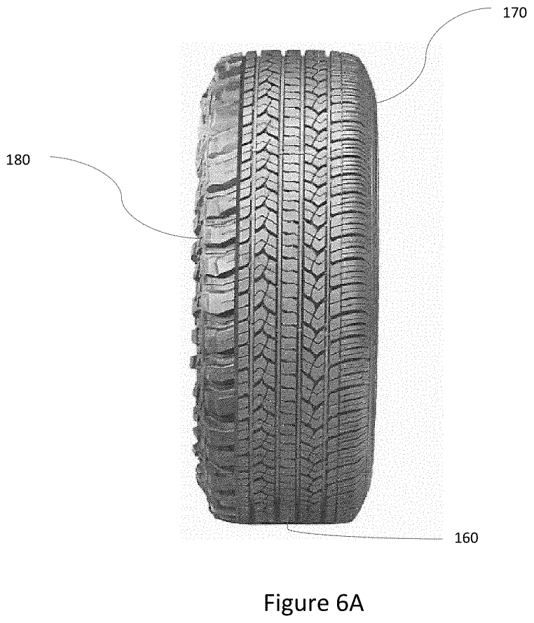

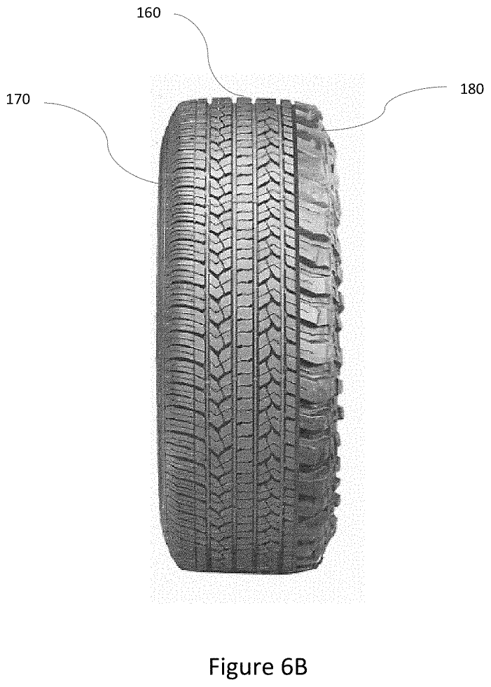

Examples can be seen in FIGS. 6A and 6B, where a crown 160 and a second (inner) shoulder 170 include high-performance tread and a first (outer) shoulder 180 includes off-road tread. By mounting the tire so that the outer shoulder 180 points outward, the tire will have the visual aesthetics of an off-road tire. And by mounting the tire so that the inner shoulder 170 points inward, the inner shoulder 170, which preferably has OM (e.g., high-performance) tread, should not rub on, or interfere with, the vehicle's wheel well or splash guard. Finally, by using an OM (e.g., high-performance) tread on the crown 160, the vehicle should exhibit a smooth and quiet ride that is fuel efficient. FIG. 7 shows an alternate embodiment where the crown 160 includes OM tread, and both shoulders 170, 180 include off-road tread. This embodiment could be used if the inner shoulder does not interfere with operation of the automobile (e.g., does not rub on the wheel well or splash guard when moved inward).

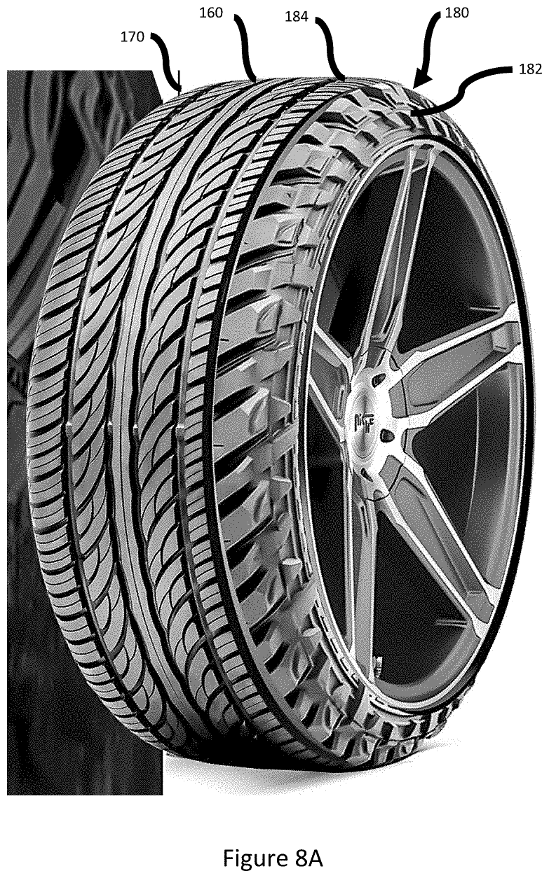

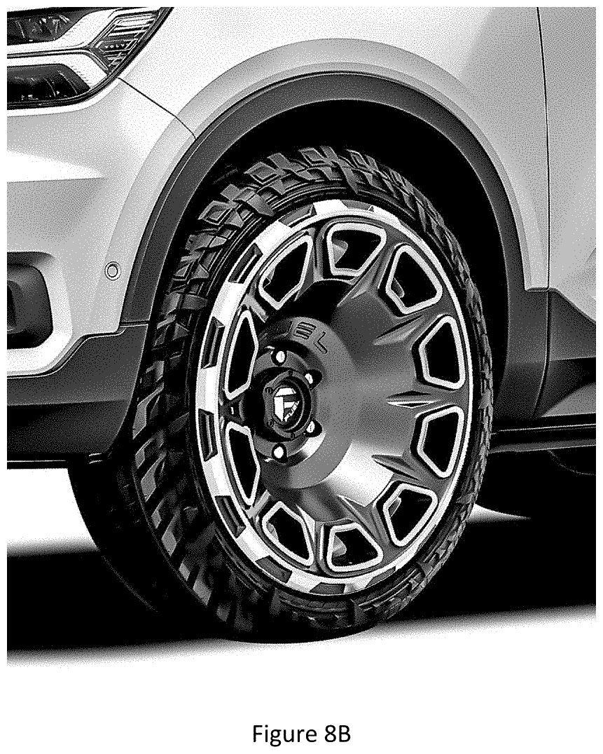

Another example is shown in FIGS. 8A and B, where 8A illustrates a tire having a crown 160 and a second (inner) shoulder 170 having a first tread design and a first (outer) shoulder 180 having a second tread design, where the first and second tread designs are different (i.e., asymmetrical). In this embodiment, the inner shoulder 170 has a first (e.g., high-performance) design and the outer shoulder 180 includes a first (upper) portion 184 (e.g., comprising transitional comfort blocks) that is configured to contact the road surface, and a second (side) portion 182 that is configured to not touch the road surface, wherein the upper portion 184 has tread that is consistent with tread on the crown 160 and second shoulder 170 (e.g., high-performance tread), and the side portion 182 has tread that is different from the tread on the second shoulder 170 (e.g., off-road). By using two different types of tread on the outer shoulder, the tire can provide a smoother, quieter ride, while exhibiting an aggressive, off-road appearance (see, e.g., FIG. 8B).

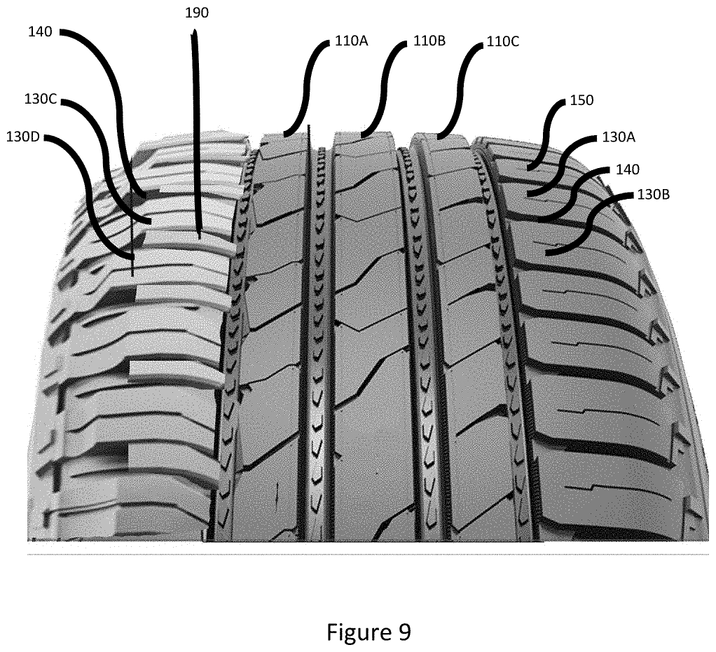

A more detailed discussion of potential differences between each shoulder will now be provided. As shown in FIG. 9, the crown may include a plurality of ribs 110A, 110B, 110C, and the first (outer) and second (inner) shoulders may include a plurality of lugs 130, grooves 140, and sipes 150, where the crown and the inner shoulder comprises a first tread (e.g., high-performance) and the outer shoulder comprises a second tread (e.g., off-road). In one embodiment, a first (upper) portion of the outer shoulder (i.e., the portion that comes into contact with the road surface) may further (or alternatively) includes a plurality of transitional comfort blocks 190 that are consistent with the first tread type (e.g., high-performance).

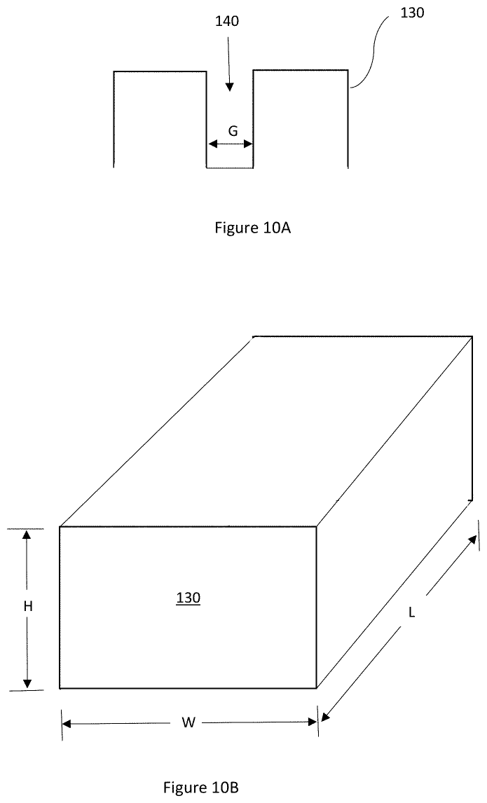

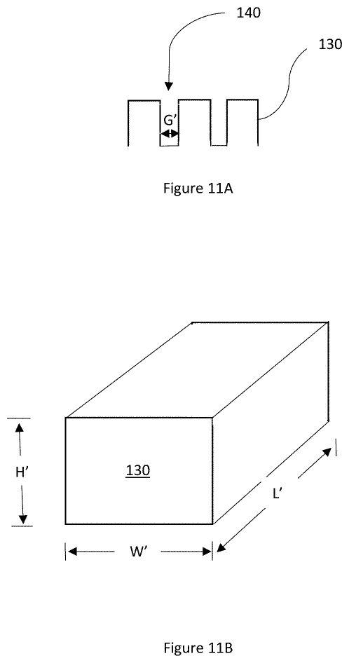

Differences between a high-performance tread and an off-road tread are illustrated in FIGS. 10A-B and 11A-B. For example, as shown in FIGS. 11A-B, a high-performance tread may include a plurality of lugs 130 separated by a plurality of grooves, where each lug 130 has at least one height H′, width W′, and length L′, and each groove has at least one height H′ and width G′. As shown in FIGS. 10A-B, the off-road tread may also have a plurality of lugs 130 separated by a plurality of grooves, where each lug 130 has at least one height H, width W, and length L, and each groove has at least one height H and width G.

As illustrated, the lugs in the off-road tread may be taller, wider, and longer than the lugs in the high-performance tread. Similarly, the grooves in the off-road tread may be deeper and wider than the grooves in the high-performance train. In other words, for the lugs, H may be greater than H′, W may be greater than W′, and L may be greater than L′, and for the grooves, H may be greater than H′ and G may be greater than G′. By using smaller ribs, lugs and grooves on the inner shoulder, the crown, and (in certain embodiments) the upper portion of the outer shoulder, and larger lugs and grooves on the side portion of the outer shoulder, an aggressive, off-road look can be provided while maintaining a smooth, quiet, comfortable ride. It should be appreciated that while the lugs are shown in FIGS. 10B and 11B as square, other shapes are within the spirit and scope of the present invention. In fact, it is quite common for lugs to be slanted, curved, etc. (see, e.g., FIGS. 1A and 1B). It should also be appreciated that while the off-road lugs are larger than high-performance lugs, the ratios may vary depending on several factors (e.g., performance, aesthetics, etc.). Thus, an off-road lug that is slightly larger than a high-performance lug (10-20% longer, wider, and/or taller to provide a smoother ride) is within the spirit and scope of the present invention, as it a much larger ratio (e.g., 75-100% longer, wider, and/or taller to provide a more aggressive look, more than 100% longer, wider, and/or taller to provide a much more exaggerated off-road look, etc.).

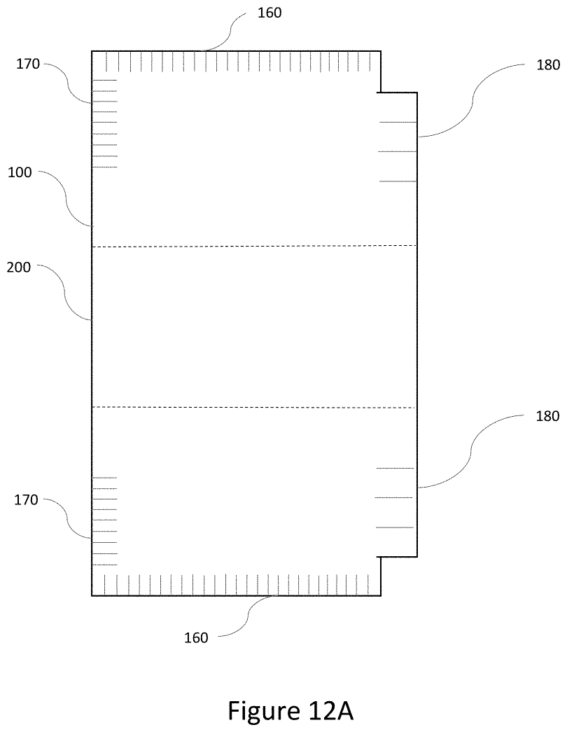

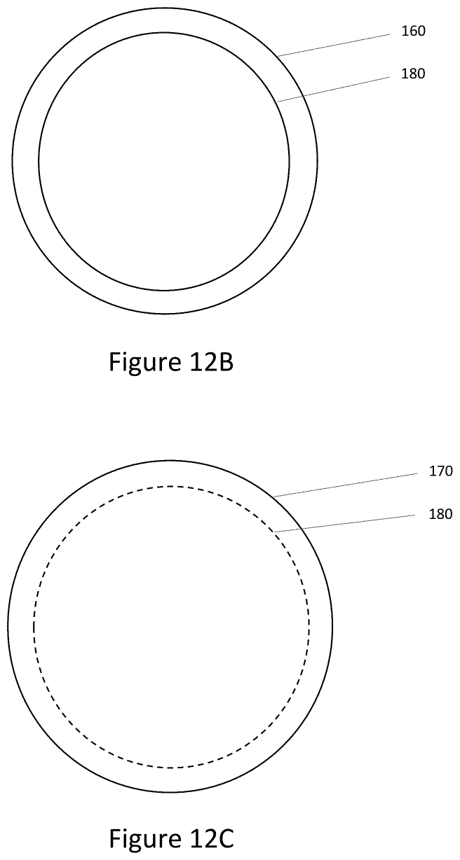

In the foregoing embodiments, the circumferences of the first and second shoulders are substantially the same (or in some cases, identical). However, in an alternate embodiment, the second shoulder may have a circumference that is less than that of the first shoulder and/or the crown. This can be seen, for example, in FIG. 12A, showing a tire 100 surrounding (e.g., affixed to) a rim 200, the tire including a crown 160, a first (inner) shoulder 170, and a second (outer) shoulder 18. As can be seen in FIGS. 12A-C, the outer shoulder's circumference is smaller (less than) the circumference of the inner shoulder 170 and the crown 160. Such an embodiment would prevent any portion of the outer shoulder 180 from coming into contact with the road surface, thereby allowing off-road tread to be on both upper and side portions of the outer shoulder.

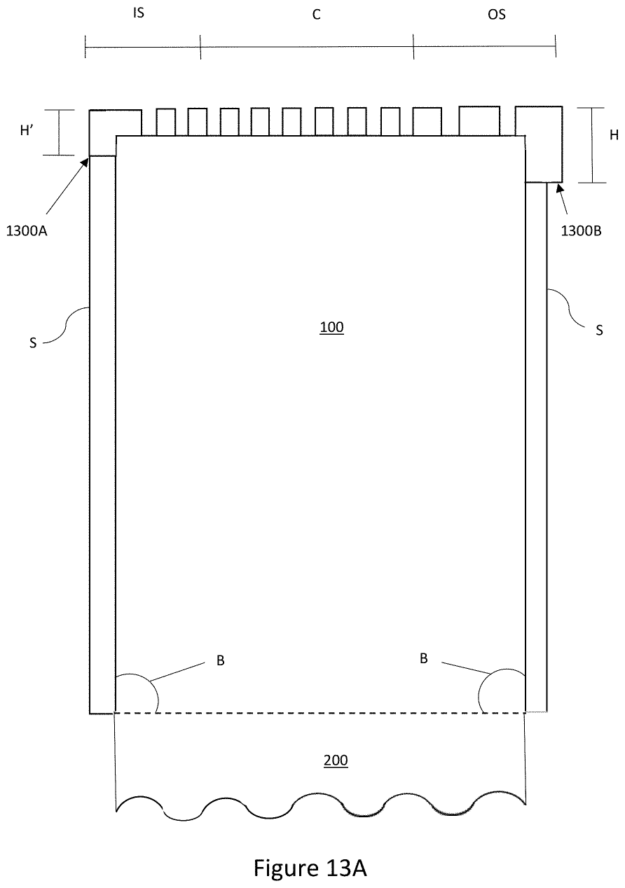

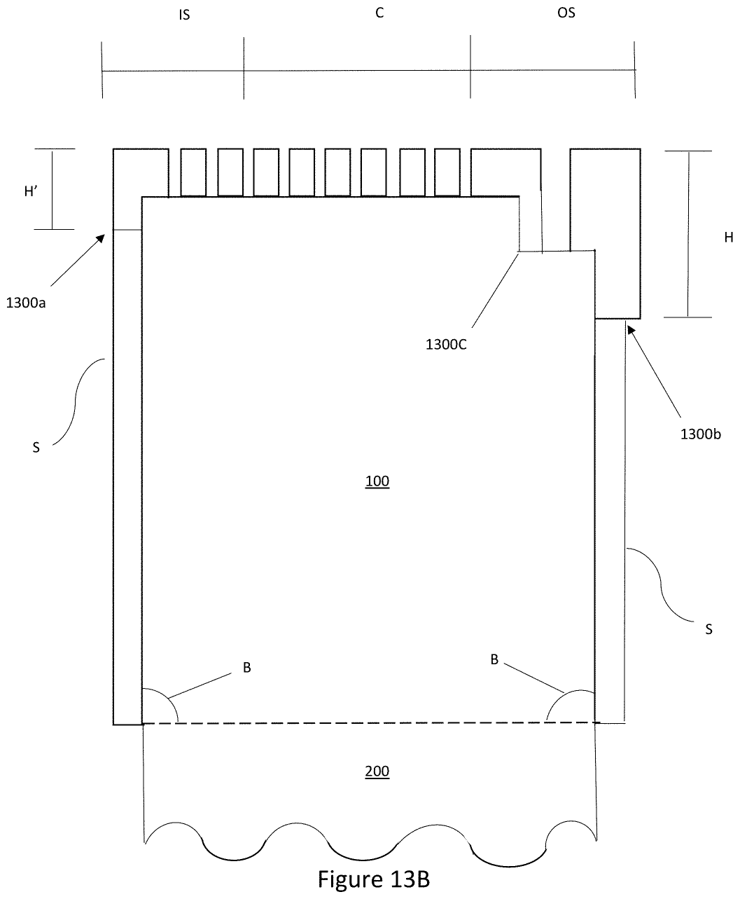

FIG. 13A shown a side cross-section of an asymmetrical tire 100 in accordance with a first embodiment of the present invention. As with traditional tires, the tire 100 includes a pair of beads B, sidewalls S, and shoulders IS, OS, and a crown C. However, unlike traditional tires, the first (outer) shoulder OS includes a first tread type (e.g., off-road) and the second (inner) shoulder IS includes a second tread type (e.g., high-performance). Preferably, the crown C also comprises the second tread type.

As previously discussed, the outer shoulder OS preferably includes an upper portion that may come into contact with a road surface and a side portion that most likely does not, but is visible once the tire is installed. As shown in FIGS. 10A, 10B, 11A, and 11B, off-road lugs are typically taller, wider, and longer than high-performance lugs. As such, use of both on the same tire could be problematic, and potentially detrimental. By way of example, a tire whose upper surface has two different tread heights would have several drawbacks (e.g., uneven wear, noise, potential loss (or minimal) traction, etc.).

To solve this, the embodiment illustrated in FIG. 13A includes a single height for tread that comes into contact with a road's surface. In other words, while the off-road lugs may be wider and longer than high-performance or all-terrain lugs, the ones on the upper portion of the outer shoulder OS should have a height that is substantially the same as (or equal to) the lugs on the upper portion of the inner shoulder IO and the ribs on the crown C (i.e., rendering all upper portions coplanar). However, in order to provide the desired appearance (e.g., aggressive, off-road), the lugs on the side portion of the outer shoulder OS should be taller than lugs on the side portion of the inner shoulder IS. As such, the lugs on the side portion of the outer shoulder may includes a shoulder (or lip) 1300b where each lug meets the sidewall. It is this shoulder that further gives the side-view of the tire its desired appearance (e.g., rugged, aggressive, etc.). In contradistinction, the lugs on the side portion of the inner shoulder IS should be coplanar with the sidewall S, creating either no shoulder or a minimal one where the inner shoulder IS meets the sidewall S (i.e., 1300a). This should prevent the tire from interfering with, or rubbing on, the wheel well or splash guard during operation.

FIG. 13B shows an asymmetrical tire in accordance with a second embodiment of the present invention. This embodiment is identical to the embodiment of FIG. 13A, with one exception, i.e., the lugs (or certain ones) on the upper portion of the outer shoulder OS are taller than the lugs on the upper portion of the inner shoulder IS. Now, because the upper portion of the tread should be coplanar, this requires a step 1300c in the floor (lower portion) of the tread, thereby creating at least one groove that is at least taller than the grooves on the upper portion of the inner shoulder IS. As previously stated, the off-road grooves may also be wider and longer than high-performance and all-terrain grooves as well. Thus, a tire may be constructed having an inner shoulder and a crown that is similar in appearance to the tire shown in FIG. 1A, and an outer shoulder that is similar in appearance to the tire shown in FIG. 1B.

It should be appreciated that because the off-road lugs (e.g., on a side portion of the outer shoulder) may be taller than the high-performance lugs (e.g., on a side portion of the inner shoulder), the width of the outer shoulder OS may be greater than a width of the inner shoulder IS. In other words, a distance from a first outer edge of the crown C to an outermost portion of the inner shoulder IS may be shorter than a second outer edge of the crown C to an outermost portion of the outer shoulder OS. Similarly, because the off-road lugs (e.g., on a side portion of the outer shoulder) may be longer than the high-performance lugs (e.g., on a side portion of the inner shoulder), the sidewall S adjacent the outer shoulder OS may be shorter (in length) than the sidewall S adjacent the inner shoulder IS. Thus, a tire having an outer shoulder whose width is greater than a width of the inner shoulder is within the spirit and scope of the present invention.

Having thus described several embodiments of the present invention, it should be apparent to those skilled in the art that certain advantages have been achieved. It should also be appreciated that various modifications, adaptations, and alternative embodiments thereof may be made within the scope and spirit of the present invention. For example, all tread types are within the spirit and scope of the present invention (e.g., all-terrain, all-season, high-performance, off-road, winter, etc.), as long as the tire includes at least two different tread types. The present invention is also not limited to the more aggressive tread type being on the outer shoulder of the tire. The purpose of the invention is to provide a visual appearance that is desired by the owner, which may be rugged, streamline, low profile, etc. Thus, any combination of the foregoing embodiments is within the spirit and scope of the present invention, which is defined solely by the following claims.

What is claimed is:

1. An asymmetrical tire for a vehicle, said tire configured to be attached to and surround a rim, said tire comprising:
a plurality of tire beads configured to contact said rim;
a tread comprising a crown and a plurality of shoulders at outer-edges of said crown, at least said crown providing traction for said vehicle on a road surface; and
a sidewall between each one of said plurality of tire beads and a corresponding one of said plurality of shoulders, wherein each one of said shoulders is a transition from said crown to a corresponding sidewall;
wherein first and second ones of said plurality of shoulders are asymmetrical to one another.

2. The tire of claim 1, wherein said first one of said plurality of shoulders includes a first set of lugs and a second one of said plurality of shoulders includes a second set of lugs, said first and second sets of lugs being asymmetrical from one another.

3. The tire of claim 2, wherein individual ones of said first set of lugs have a height that is greater than individual ones of said second set of lugs.

4. The tire of claim 2, wherein individual ones of said first set of lugs have a width that is greater than individual ones of said second set of lugs.

5. The tire of claim 2, wherein said first set of lugs have a length that is greater than individual ones of said second set of lugs.

6. The tire of claim 2, wherein said first one of said plurality of shoulders includes a first set of grooves and said second one of said plurality of shoulders includes a second set of grooves, said first and second sets of grooves being asymmetrical to one another.

7. The tire of claim 6, wherein individual ones of said first set of grooves have a height that is greater than individual ones of said second set of grooves.

8. The tire of claim 6, wherein individual ones of said first set of grooves have a width that is greater than individual ones of said second set of grooves.

9. The tire of claim 6, wherein said crown comprises a plurality of symmetrical ribs between said plurality of shoulders.

10. The tire of claim 6, wherein said first one of said plurality of shoulders includes a first set of sipes and said second one of said plurality of shoulders includes a second set of sipes, said first and second sets of sipes being asymmetrical to one another.

11. The tire of claim 1, wherein a first one of said plurality of shoulders has a circumference that is substantially equal to a circumference of a second one of said plurality of shoulders.

12. The tire of claim 1, wherein a first one of said plurality of shoulders has a circumference that is smaller than a circumference of a second one of said plurality of shoulders.

13. The tire of claim 2, wherein said first and second sets of lugs are on side portions of said first and second ones of said plurality of shoulders, respectively, wherein said side portions of said first and second ones of said plurality of shoulders are configured to not touch said road surface.

14. The tire of claim 13, wherein said first set of lugs has a height that is greater than said second set of lugs.

15. A tire apparatus, comprising:
a pair of tire beads;
a tread portion comprising a crown and a pair of shoulders, said crown and upper portions of said pair of shoulders coming into contact with a road surface during operation, each one of said pair of shoulders including a side portion that does not come into contact with said road surface during operation; and
a pair of sidewalls, each one of said pair of sidewalls being located between a corresponding one of said pair of tire beads and a corresponding one of said pair of shoulders;
wherein a first one said pair of shoulders has an outer-surface design that is different from an outer-surface design of a second one of said pair of shoulders.

16. The apparatus of claim 15, wherein said outer-surface of said first one of said pair of shoulders has a first lug that is shaped differently from a second lug on an outer-surface of said second one of said pair of shoulders.

17. The apparatus of claim 16, wherein said first lug has at least one of a height, width, and length that is greater than said second lug.

18. The apparatus of claim 16, wherein said outer-surface of said second one of said pair of shoulders has a first groove adjacent said first lug that is shaped differently from a second groove adjacent said second lug on said outer-surface of said second one of said pair of shoulders.

19. The apparatus of claim 18, wherein said first groove has at least one of a height and width that is greater than said second groove.

20. The apparatus of claim 17, wherein said first lug is on said side portion of said first one of said pair of shoulders and said second lug is on said side portion of said second one of said pair of shoulders.
